(19) United States
(12) Patent Application Publication
(10) Pub. No.: US 2009/0002305 A1
(43) Pub. Date: Jan. 1, 2009

(54) Liquid crystal display with common voltage generator for reducing crosstalk

(75) Inventor: Sheng-Tien Cho, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 12/215,439

(22) Filed: Jun. 27, 2008

(30) Foreign Application Priority Data
Jun. 29, 2007 (CN) 200710076263.0

(51) Int. Cl. G09G 3/36

(52) U.S. Cl. 345/94

(57) ABSTRACT

An exemplary liquid crystal display (20) includes a liquid crystal display panel (22), data lines (26) connected to the liquid crystal display panel, and a common voltage generator (24) configured to output a common voltage to the liquid crystal display panel. A predetermined number of the data lines are also connected to the common voltage generator. The common voltage generator generates a common voltage according to data signals received from the predetermined number of data lines.

### FIELD OF THE INVENTION

The present invention relates to liquid crystal displays (LCDs), and more particularly to a liquid crystal display with a common voltage generator for reducing crosstalk.

### GENERAL BACKGROUND

Typical LCDs provide advantages of portability, low power consumption, and low radiation. LCDs have thus been widely applied in various portable information products such as notebooks, personal digital assistants (PDAs), video cameras, and the like.

FIG. 5 is a schematic, abbreviated diagram of certain components of a conventional LCD 10, in which LCD 10 includes a liquid crystal display panel (not labeled), a gate driver 11, and a data driver 12.

The liquid crystal panel includes a plurality of parallel gate lines 13 each extending along a first axis, a plurality of parallel data lines 14 each extending along a second axis orthogonal to the first axis, and a plurality of pixel units (not labeled) defined by the intersecting gate lines 13 and data lines 14. The gate driver 11 is provided to drive the gate lines 13. The data driver 12 is provided to drive the data lines 14.

Each pixel unit comprises a thin film transistor (TFT) 15, a pixel electrode 18, a common electrode 19, and a pixel capacitor (not labeled) defined by the pixel electrode 18 and the common electrode 19. The pixel capacitor includes a liquid crystal capacitor 16, and a supplementary capacitor 17 connected in parallel with the liquid crystal capacitor 16. A source electrode (not labeled) of the TFT 15 is connected to a corresponding data line 14. A gate electrode (not labeled) of the TFT 15 is connected to a corresponding gate line 13. A drain electrode (not labeled) of the TFT 15 is connected to the pixel electrode 18.

In operation, the gate driver 11 applies a plurality of gate signals, one at a time, to the gate lines 13, such that, at any given time, only one of the gate lines 13 has a gate signal applied thereto, during which time TFTs 15 connected to the gate line 13 are turned on. The data driver 12 applies a plurality of data signals to the data lines 14. Each data signal is transmitted to each corresponding pixel electrode 18 via a corresponding turned-on TFT 15. Thereby, a voltage difference is generated between the pixel electrode 18 and the corresponding common electrode 19 by the data signal applied to the pixel electrode 18 and a common voltage applied to the common electrode 19. The voltage difference controls the array angles of liquid crystal molecules, thereby controlling light transmission of the corresponding pixel unit.

To improve displayed images, the LCD 10 typically employs a dot-inversion driving method, wherein voltages applied to each pixel electrode 18 have a positive polarity and then a negative polarity, relative to the common voltage. The voltage polarities of the data signals convert when corresponding TFTs 15 are turned on. However, due to parasitic capacitors between the data lines 14 and the common electrodes 19, the data signals pull the common voltage up or down via the parasitic capacitors at the moment that the TFTs 15 are turned on, as shown in FIG. 6. In addition, it usually takes time for the common voltage to return to its original level. This causes crosstalk in the LCD 10. This in turn may lead to flickering of images displayed by the LCD 10.

What is needed, therefore, is an LCD which can overcome the limitations described.

### SUMMARY

A liquid crystal display comprises a liquid crystal display panel with a plurality of data lines connected thereto and a common voltage generator configured to output a common voltage to the liquid crystal display panel. A predetermined number of the data lines are also connected to the common voltage generator. The common voltage generator generates a common voltage according to data signals received from the predetermined number of data lines.

Other novel features and advantages will become more apparent from the following detailed description when taken in conjunction with the accompanying drawings. In the drawings, all views are schematic.

### BRIEF DESCRIPTION OF THE DRAWINGS

FIG. 1 is an abbreviated diagram of certain components of an LCD according to a first embodiment of the present invention, the LCD including a common voltage generator.

FIG. 2 is a circuit diagram of the common voltage generator.

FIG. 3 is a timing chart illustrating a common voltage influenced by data signals of the LCD of FIG. 1.

FIG. 4 is an abbreviated diagram of certain components of an LCD according to a second embodiment of the present invention.

FIG. 5 is an abbreviated diagram of certain components of a conventional LCD.

FIG. 6 is a timing chart illustrating a common voltage influenced by data signals of the LCD of FIG. 5.

### DETAILED DESCRIPTION OF PREFERRED EMBODIMENTS

Reference will now be made to the drawings to describe preferred and exemplary embodiments in detail.

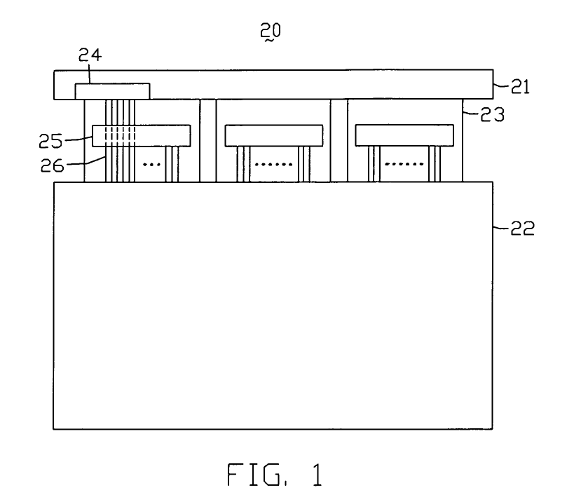

FIG. 1 is a schematic, abbreviated diagram of certain components of an LCD 20 according to a first embodiment of the present invention. The LCD 20 includes a printed circuit board (PCB) 21, a liquid crystal display panel 22, and a number of flexible printed circuit boards (FPCBs) 23. The PCB 21 is connected to the liquid crystal display panel 22 via the FPCBs 23.

Each of the FPCBs 23 includes a plurality of data lines 26 extending into the liquid crystal display panel 22, and a data driver 25 for driving the data lines 26. The PCB 21 includes a common voltage generator 24. In the illustrated embodiment, six data lines 26 among all of the data lines 26 also extend into the common voltage generator 24. In the illustrated embodiment, the six data lines 26 are located at the one same FPCB 23, and are adjacent to each other.

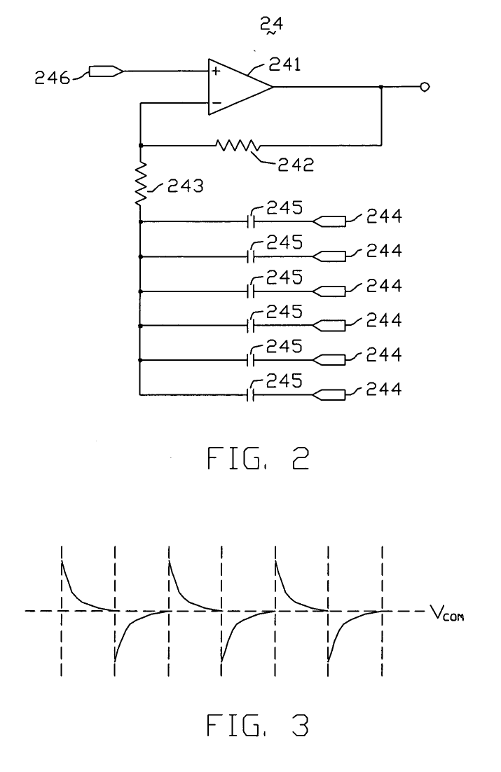

FIG. 2 is a circuit diagram of the common voltage generator 24, comprising an inverting-amplifier 241, a first resistor 242, a second resistor 243, six coupling capacitors 245, six first input terminals 244, and a second input terminal 246. In the illustrated embodiment, the resistances of the first and second resistors 242, 243 are respectively R1 and R2.

The six data lines 26 are connected to the six first input terminals 244, respectively. Each of the first input terminals 244 is connected to a corresponding terminal (not labeled) of the second resistor 243 via one coupling capacitor 245, respectively. The other terminal of the second resistor 243 is connected to a negative input terminal (not labeled) of the inverting-amplifier 241. A positive input terminal (not labeled) of the inverting-amplifier 241 is connected to the second input terminal 246. An output terminal (not labeled) of the inverting-amplifier 241 provides a common voltage for the LCD 20, and is connected to the negative input terminal via the first resistor 242.

In operation, the positive input terminal of the inverting-amplifier 241 receives a reference voltage V_{ref}. Thereby, the common voltage generator 24 outputs a stable common voltage V_{com}. When TFTs (not shown) of the liquid crystal display panel 22 are turned on, the common voltage may be pulled up or down by the influence of the data signals, due to parasitic capacitors that exist between the data lines 26 and a common electrode (not shown).

Simultaneously, six data signals are applied to the six first input terminals 244 of the common voltage generator 24 via the six data lines 26, respectively. Thereby, a total voltage Vᵢₙ is applied to the negative input terminal of the inverting-amplifier 241. In the present embodiment, Vᵢₙ is expressed as:

Vᵢₙ=V1+V2+V3+V4+V5+V6 (1)

where V1, V2, V3, V4, V5, and V6 respectively represent the six data signals. As a result, the inverting-amplifier 241 outputs a common voltage Vₒᵤₜ having a reverse phase. In the present embodiment, Vₒᵤₜ is expressed by:

Vₒᵤₜ=(R1/R2)*(V_{ref}−Vᵢₙ)+V_{ref} (2)

Therefore, when the common voltage V_{com} is pulled down or up by the data signals, the common voltage generator 24 outputs a reverse phase common voltage Vₒᵤₜ. The two voltages V_{com}, Vₒᵤₜ are superimposed, thus the pulled-down or pulled-up common voltage is soon pulled back, as shown in FIG. 3.

As described, the common voltage generator 24 outputs the common voltage Vₒᵤₜ according to the data signals. When the common voltage V_{com} is pulled down or up by the data signals, the common voltage generator 24 outputs a reverse phase common voltage Vₒᵤₜ. The two voltages V_{com}, Vₒᵤₜ are superimposed, thus the pulled-down or pulled-up common voltage is soon pulled back. As a result, any crosstalk in the LCD 20 is reduced or even eliminated. Accordingly, flickering of images displayed by the LCD 10 can be reduced or even eliminated.

Furthermore, there are only six data lines 26 connected to the common voltage generator 24, located at the FPCBs 23. The LCD 20 with this structure can be easily made.

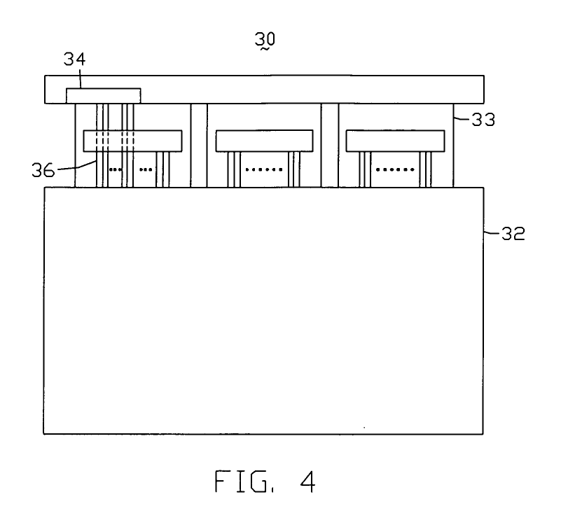

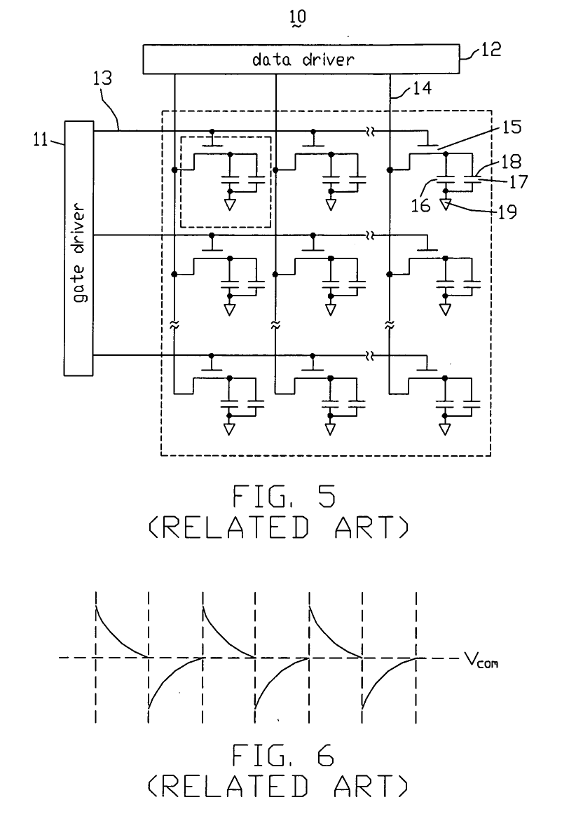

FIG. 4 is a schematic, abbreviated diagram of certain components of an LCD 30 according to a second embodiment of the present invention. The LCD 30 has a structure similar to that of the LCD 20. However, six data lines 36 extending into a common voltage generator 34 are divided into two separate groups (not labeled). Each group includes three adjacent data lines 36.

Various modifications and alterations to the above-described embodiments are possible. For example, 6n (where n is a positive integer) data lines 26 may extend into the common voltage generator 24. The 6n data lines 23 may respectively connect to 2n red pixel units, 2n green pixel units, and 2n blue pixel units of the liquid crystal display panel 22. The 6n data lines 26 can be adjacently located at one of the FPCBs 23. The 6n data lines can instead be located at at least two of the FPCBs 23.

It is to be further understood that even though numerous characteristics and advantages of the present embodiments have been set out in the foregoing description, together with details of the structures and functions of the embodiments, the disclosure is illustrative only; and that changes may be made in detail, especially in matters of shape, size, and arrangement of parts within the principles of the invention to the full extent indicated by the broad general meaning of the terms in which the appended claims are expressed.

What is claimed is:

1. A liquid crystal display, comprising:
a liquid crystal display panel;
a plurality of flexible printed circuit boards connected to the liquid crystal display panel;
a plurality of data lines located at the flexible printed circuit board and extending into the liquid crystal display panel; and
a common voltage generator configured to provide a common voltage to the liquid crystal display panel;
wherein a plurality of the plurality of data lines also extend into the common voltage generator, and the common voltage generator is configured for adjusting the common voltage according to data signals received from said plurality of the plurality of data lines.

2. The liquid crystal display of claim 1, wherein the number of said plurality of the plurality of data lines is 6n, where n is a positive integer.

3. The liquid crystal display of claim 2, wherein the 6n data lines are located at one of the flexible printed circuit boards.

4. The liquid crystal display of claim 3, wherein the 6n data lines are located adjacent to each other at said one of the flexible printed circuit boards.

5. The liquid crystal display of claim 2, wherein the 6n data lines are located at at least two of the flexible printed circuit boards.

6. The liquid crystal display of claim 1, wherein the common voltage generator comprises an amplifier, the amplifier configured for adjusting the common voltage according to a reference voltage and the data signals received from said plurality of the plurality of data lines.

7. The liquid crystal display of claim 6, wherein the amplifier is an inverting amplifier.

8. The liquid crystal display of claim 6, wherein when the total voltages of the data signals exceed the reference voltage, the common voltage output by the common voltage generator is pulled down.

9. The liquid crystal display of claim 6, wherein when the total voltages of the data signals are lower than the reference voltage, the common voltage output by the common voltage generator is pulled up.

10. The liquid crystal display of claim 6, wherein the amplifier comprises a positive input terminal configured to receive the reference voltage, a negative input terminal configured to receive the data signals, and an output terminal configured to output the common voltage.

11. The liquid crystal display of claim 10, wherein the common voltage generator further comprises a first resistor connected between the negative input terminal and the output terminal of the amplifier.

12. The liquid crystal display of claim 11, wherein the common voltage generator further comprises a plurality of coupling capacitors, and said plurality of the plurality of data lines are respectively connected to the common voltage generator via the coupling capacitors.

13. The liquid crystal display of claim 12, wherein the common voltage generator further comprises a second resistor connected between the coupling capacitors and the negative input terminal of the amplifier.

14. A liquid crystal display, comprising:
a liquid crystal display panel;
a plurality of data lines connected to the liquid crystal display panel; and
a common voltage generator configured to output a common voltage to the liquid crystal display panel;
wherein a plurality of the plurality of data lines are connected to the common voltage generator, and the common voltage generator is configured to generate a common voltage according to data signals received from said plurality of the plurality of data lines.

15. The liquid crystal display of claim 14, wherein the common voltage generator comprises an amplifier, the amplifier configured for adjusting the common voltage according to a reference voltage and the data signals received from said plurality of the plurality of data lines.

16. The liquid crystal display of claim 15, wherein when the total voltages of the data signals exceed the reference voltage, the common voltage output by the common voltage generator is pulled down.

17. The liquid crystal display of claim 15, wherein when the total voltages of the data signals are lower than the reference voltage, the common voltage output by the common voltage generator is pulled up.
